(19) United States
(12) Patent Application Publication
(10) Pub. No.: US 2026/0178291 A1
(43) Pub. Date: Jun. 25, 2026

(54) ENHANCED CYBER-RESILIENCY IN BYZANTINE FAULT TOLERANT TECHNOLOGY

(71) Applicant: Dell Products L.P., Round Rock, TX (US)

(72) Inventors: Werner Spolidoro Freund, Rio de Janeiro (BR); Roberto Nery Stelling Neto, Rio de Janeiro (BR); Vinicius Facco Rodrigues, São Paulo (BR); Victor da Cruz Ferreira, Rio de Janeiro (BR); Vicente J.P. Amorim, João Monlevade (BR)

(21) Appl. No.: 18/988,394

(22) Filed: Dec. 19, 2024

(51) Int. Cl. G06F 8/36; G06F 8/60; G06F 11/3668

(52) U.S. Cl. CPC G06F 8/36; G06F 8/60; G06F 11/3688

(57) ABSTRACT

The disclosed method involves utilizing a machine learning model to process a plurality of task descriptions corresponding to individual tasks of a divided algorithm or application. The model generates multiple code snippets for each task description, which are then stored in a code snippets database. This database is designed to accommodate updates to metadata associated with the code snippets, where the metadata provides information regarding the state of the code snippets. A subset of these stored code snippets is combined to create node replication codes, which, upon deployment, facilitate the generation of node replications within a platform. The deployment of these node replication codes on the platform results in the creation of node replications.

### TECHNOLOGICAL FIELD OF THE DISCLOSURE

Embodiments disclosed herein generally relate to enhanced cyber-resiliency in systems. More particularly, at least some embodiments relate to systems, hardware, software, computer-readable media, and methods for generating in system node replications having a high degree of variation.

### BACKGROUND

The growing demand for highly scalable technological infrastructure has raised security, reliability and scalability concerns which led many companies to shift their priorities to provide safer and more reliable environments. With that in mind, Byzantine Fault Tolerant (BFT) protocols play an important role in maintaining system coherence and reliability in the presence of Byzantine faults. BFT requirements will be present in any area where consensus and fault tolerance are of the essence. For example, Time Protocols in packet switched networks have explicit Byzantine requirements. Furthermore, Byzantine implementations can allow systems to continue to work correctly even when there are software errors.

A natural way to increase reliability is to add replicated nodes in a system, however, increasing the number of nodes in any BFT system may pose a problem if all nodes share the same vulnerabilities. If a vulnerability is shared by all replicas, then all can be attacked at the same time.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of Byzantine Fault Tolerant (BFT) protocols.

FIG. 2A discloses aspects of a system in which the embodiments disclosed herein may be implemented.

FIG. 2B discloses aspects of a division component of the system of FIG. 2A.

FIG. 2C discloses aspects of a code generation of the system of FIG. 2A.

FIG. 2D discloses aspects of a Large Language Model of the system of FIG. 2A.

FIG. 2E illustrates aspects of a code snippets database of the system of FIG. 2A.

FIG. 2F discloses aspects of a monitoring component of the system of FIG. 2A.

FIG. 3 discloses aspects of a method according to one embodiment.

FIG. 4 discloses a computing entity configured and operable to perform any of the disclosed methods, processes, and operations.

### DETAILED DESCRIPTION OF SOME EXAMPLE EMBODIMENTS

Embodiments disclosed herein generally relate to enhanced cyber-resiliency in systems. More particularly, at least some embodiments relate to systems, hardware, software, computer-readable media, and methods for generating in system node replications having a high degree of variation.

In some aspects, the embodiments described herein relate to a method, including: receiving at a machine learning model a plurality of task descriptions for individual tasks of an overall algorithm or application that has been divided into the individual tasks; generating, at the machine learning model, a plurality of code snippets for each of the plurality of task descriptions; storing the plurality of code snippets in a code snippets database, the code snippets database being configured to receive updates to metadata included in the plurality of code snippets, the metadata including information about a state of the plurality of code snippets; combining a subset of the plurality of code snippets stored in the code snippets database to generate a plurality of node replication codes that are configured, when deployed, to generate node replications in a platform; and deploying the plurality of node replication codes at the platform to thereby generate the node replications in the platform.

In some aspects, the embodiments described herein relate to a non-transitory storage medium having stored therein instructions that are executable by one or more hardware processors to perform operations including: receiving at a machine learning model a plurality of task descriptions for individual tasks of an overall algorithm or application that has been divided into the individual tasks; generating, at the machine learning model, a plurality of code snippets for each of the plurality of task descriptions; storing the plurality of code snippets in a code snippets database, the code snippets database being configured to receive updates to metadata included in the plurality of code snippets, the metadata including information about a state of the plurality of code snippets; combining a subset of the plurality of code snippets stored in the code snippets database to generate a plurality of node replication codes that are configured, when deployed, to generate node replications in a platform; and deploying the plurality of node replication codes at the platform to thereby generate the node replications in the platform.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments is that node replications of various platforms may be generated that have a high degree of variation. Because of the variation in the node replications, the node replications are less susceptible to the same type of cyber-attack, thus increasing the resiliency platforms.

### A. Context for an Example Embodiment

The following is a discussion of aspects of example operating environments for various embodiments. This discussion is not intended to limit the scope of the claims or this disclosure, or the applicability of the embodiments, in any way.

The embodiments disclosed herein implement one or more machine learning (ML) models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees), linear regression model(s), logistic regression model(s), support vector machine(s) (“SVM”), artificial intelligence device(s), Large Language model(s), or any other type of intelligent computing system. Any amount of training data may be used (and perhaps later refined) to train the machine learning algorithm to dynamically perform the disclosed operations.

The embodiments disclosed herein add a layer of variability to Byzantine Fault Tolerant (BFT) protocol implementations, aiming to decrease the correlation of vulnerabilities in BFT replicas. In most BFT implementations, each node, or replica, is simply a copy of the same program running on different machines, virtual or physical, or even containers. This approach, although practical, opens a common attack vector to all replicas, as a vulnerability present in one of the nodes will likely be present in all the others. A properly orchestrated attack could eventually be performed in all the nodes at the same time, exploiting the same vulnerability, effectively taking control over the BFT system before any measure could be taken to prevent it or reduce its impact.

In the embodiments disclosed herein, the generation of the code for a BFT node replica is broken in the following steps:
1. The BFT algorithm is split into small atomic parts, as small and independent as possible, given the constraints of the underlying BFT protocol. This phase could be performed manually, using traditional development techniques. The output will be n high level procedure descriptions, that can be used to feed a Large Language Model that will generate corresponding code snippets in the desired languages and platforms.
2. All the generated code snippets of the desired split are maintained in a database where it can be used to build a complete solution. In some embodiments, a certain split will have different definitions (wordings or prompts) to add as much variability as possible to the desired output.
3. The various snippets combinations of a split will be used to generate a deployable solution in as many platforms and languages as desirable.
4. The resulting combination is then tested and deployed as needed. The whole execution environment is also monitored, to make sure that it is working in the desired specifications and has not been exploited.

### A.1 Byzantine Fault Tolerant Protocols

BFT technology typically deals with the problem of establishing consensus in a network of stakeholders (nodes) when communicating asynchronously in the presence of faulty components or malicious actors with a common interest. It has been demonstrated that in a set of n nodes, the constraint of n≥3f+1 holds, where f is the number of malicious or faulty nodes. It is important to note that all messages exchanged in all pBFT phases are cryptographically signed. This makes the process of impersonating other nodes not practical when strong cryptography is employed. A BFT quorum is considered the subset of nodes within the BFT network that must collectively agree on a decision for the decision to be considered valid.

There is a plethora of protocols providing different trade-offs between communication bandwidth, latency, processing, and fault resiliency. Currently, most well-known BFT protocols concern cryptocurrency use-cases. However, BFT protocols are also usable in Zero-Trust systems and protocols.

A.2 Practical BFT Protocol (pBFT)

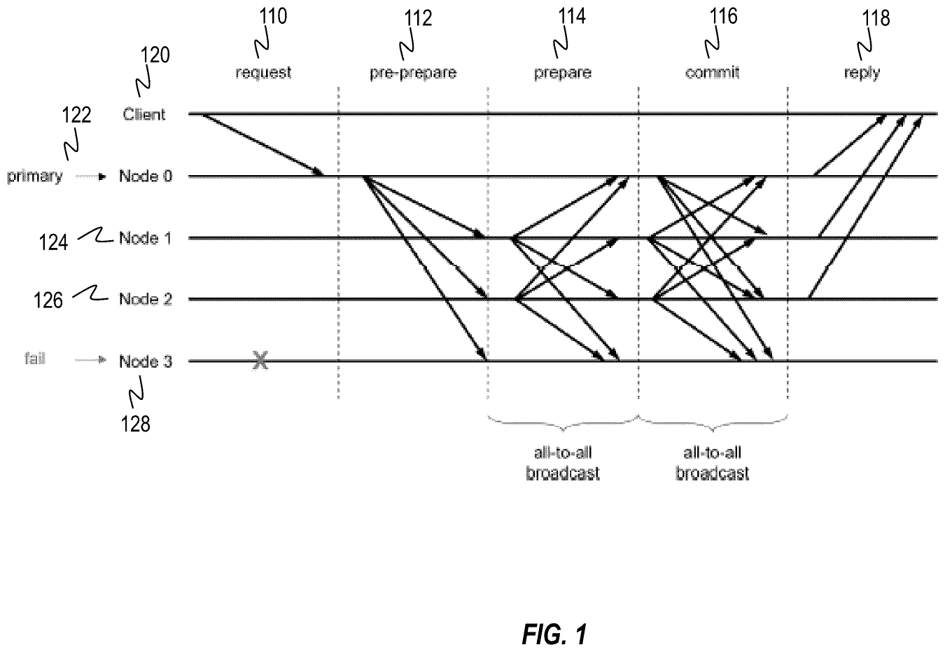

The practical BFT (pBFT) protocol is composed of five phases as illustrated in FIG. 1. These five phases are the request phase 110, the pre-prepare phase 112, the prepare phase 114, the commit phase 116, and the reply phase 118.

In the request phase 110, a client 120 starts the protocol by requesting a validation or some operation that requires consensus for the system. A primary node 122 is responsible for receiving the client 120 request and starting the pre-prepare phase 112, the prepare phase 114, and the commit phase 116. The prepare phase 114, and the commit phase 116 require an all-to-all broadcast.

The practical BFT protocol proceeds as follows:
1. In the pre-prepare phase 112, the primary node 122 generates a new view and submits transactions associated with it in a message via broadcast.
2. Once one or more of the non-primary nodes 124, 126, and 128 accepts the pre-prepare message, the nodes enter the prepare phase 114 and then broadcasts a signed prepare message to all the nodes in the view.
3. If a node receives 2f different prepare messages which matches its accepted pre-prepare message, it can start the commit phase 116.
4. In the commit phase 116, if a node receives 2f+1 different commit messages matching its accepted pre-prepare and prepare messages, it commits the transactions and replies to the client 120 during the reply phase 118
5. The transactions are considered correct when the client 120 receives f+1 identical results or responses from different nodes in the same view defined by the primary node 122.

In the embodiment of FIG. 1, the client 120 receives f+1 identical results or responses from the nodes 122, 124, and 126. However, there is a failure with respect to node 128 as it does not broadcast any messages to the other nodes.

### B. Overview of Aspects of One or More Embodiments

### B.1 Introduction

In the embodiments disclosed herein, a GenAI-based orchestration framework for Automatic N-Version-Programming and System Monitoring with the goal of enhancing BFT cyber-resiliency is presented. The embodiments produce a framework that includes combinations of different code variations, in multiple languages and platforms of various sub-routines of an application that will be replicated on a mission critical environment. The aggregate combination of multiple code instances, languages and platform variations improve resiliency of replicated environments as it reduces the correlation of vulnerabilities, mitigates risks, and reduce the impact of eventual bugs that may be found in the resulting applications. For example, a zero-day vulnerability in a library of a certain language in a specific platform could eventually be found, and potentially explored, but its impact would be restricted to a minimal subset of replicas, not enough to disrupt the BFT resiliency.

In some embodiments, the disclosed framework is incorporated into BFT-based algorithms as it represents an important security solution being the basis of Distributed Ledger Technology (DLT) and provides distinct steps which fit well with the disclosed framework. BFT protocols assume that each instance, or node, is independent of each other in terms of their vulnerabilities, as a single vulnerability that can affect all nodes, or even a subset of the right size of the nodes, simultaneously can put the whole consensus mechanism at risk.

### B.2 Embodiments

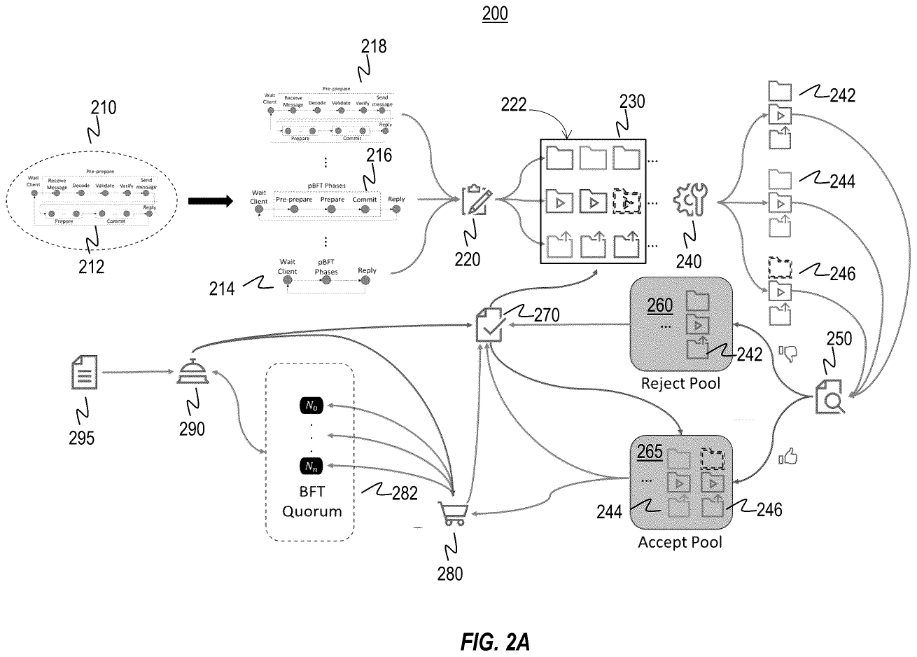

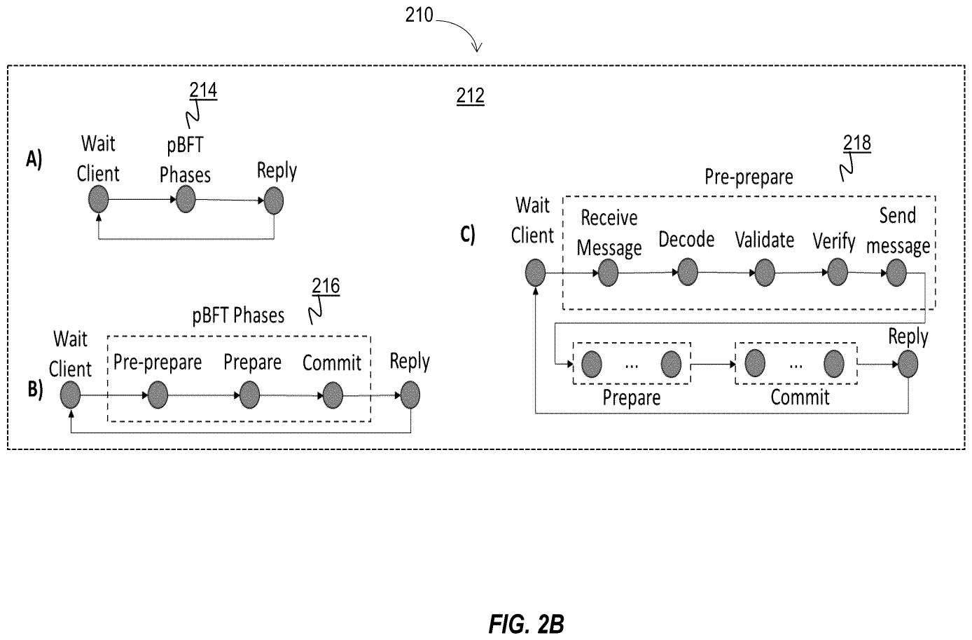

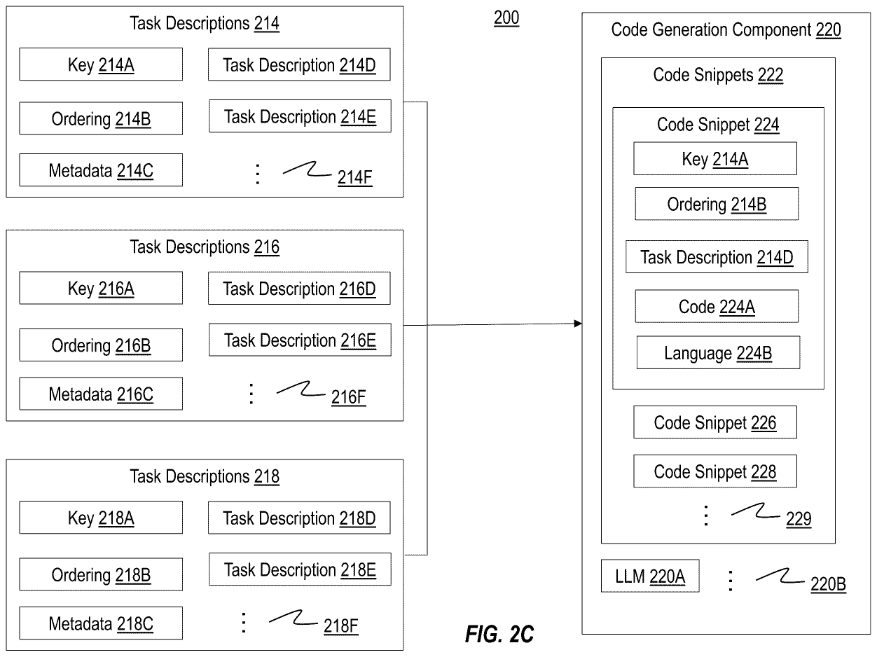

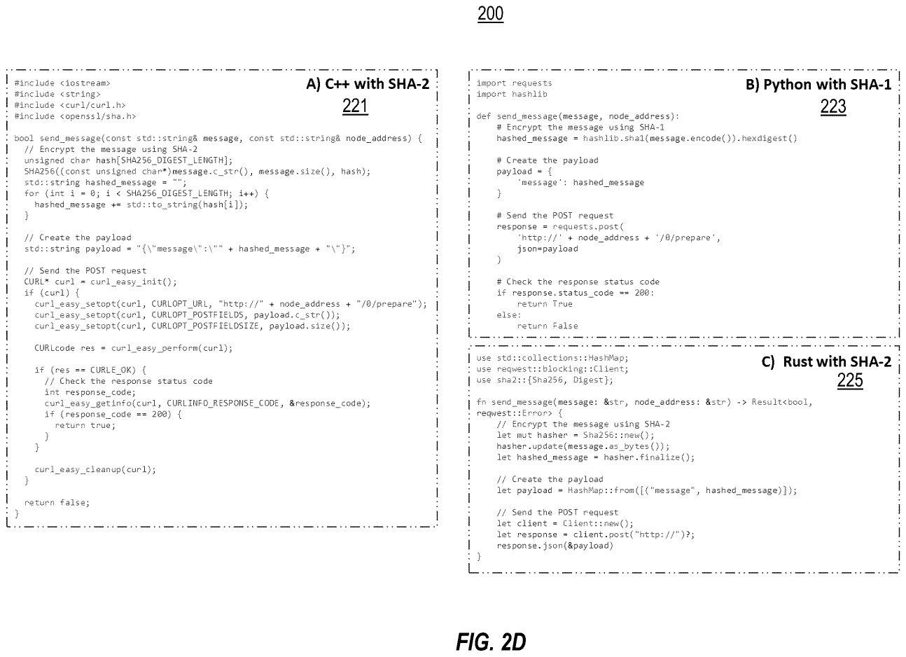

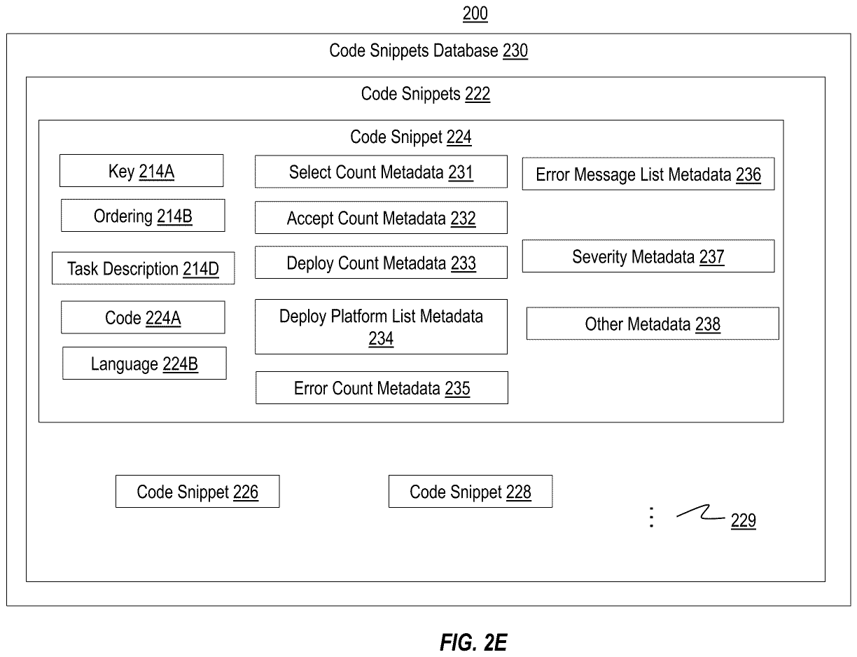

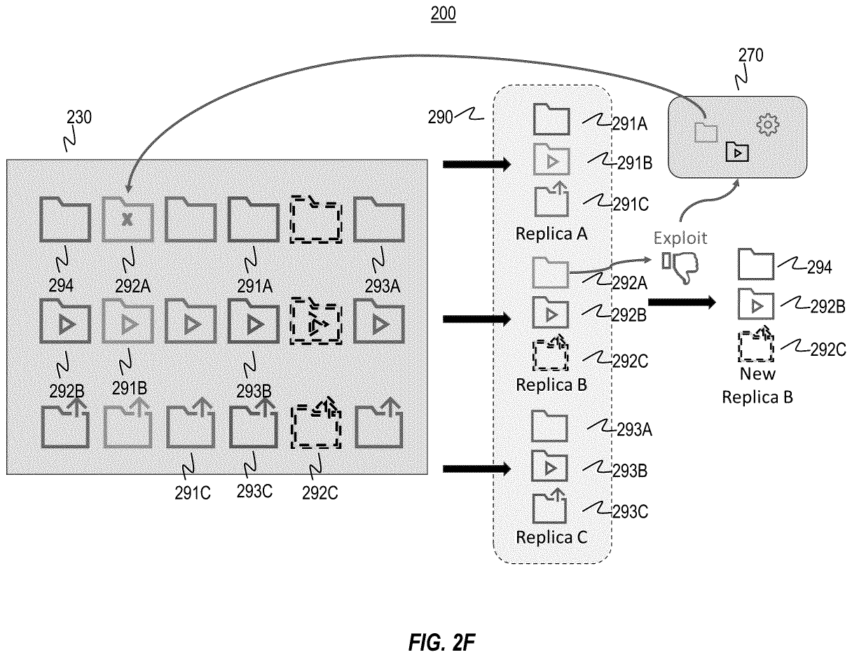

FIG. 2A illustrates an example embodiment of a system 200 in which the embodiments disclosed herein may be implemented. As illustrated, the system 200 includes an algorithm division component 210 where a target algorithm 212 is split into smaller or atomic task descriptions in a state machine-like flow. In some embodiments, the target algorithm 212 may be manually split by a user of the system 200. As illustrated, the target algorithm 212, which may be any algorithm or application that is able to be divided into the smaller task descriptions, is divided into the smaller tasks descriptions 214, 216, and 218. In the embodiment, the target algorithm is the pBFT protocol described previously and the smaller tasks descriptions 214, 216, and 218 are smaller task descriptions of the pBFT protocol.

FIG. 2B illustrates a more detailed view of the division component 210. As previously described, the division component 210 divides an application or algorithm such as the target algorithm 212 into smaller tasks or states. The granularity of the task is dependent on a use-case since the smaller tasks will be converted into code snippets as will be explained in more detail to follow. Thus, in some embodiments having a task as fine-grained as possible decreases the likelihood of generation errors when using a Large Language Model to generate the code snippets. On the other hand, the use of different granularities or variations on the definitions of the tasks to generate code with the same desired functionality can improve the overall resiliency by adding another dissimilarity layer to the combined implementations.

In FIG. 2B, three different levels of granularity for the pBFT algorithm are shown in state machine diagrams. Because the pBFT algorithm is mostly sequential within a node, synchronous, and has well defined phases, the split is straightforward. At granularity A, a minimal split is performed to generate the tasks description 214 that includes individual tasks for the request and reply phases discussed in FIG. 1 while the other phases are agglomerated into an individual task. At granularity B, a split is performed to generate the tasks description 216 that includes individual tasks for each phase discussed in FIG. 1, that is the reply, pre-prepare, prepare, commit, and reply phases. At granularity C, a split is performed to generate the tasks description 218 that includes individual tasks for fine-grained phases for the pre-prepare, prepare, commit phases. Specifically, as shown in FIG. 2B the pre-prepare phase includes a receive message phase, a decode phase, a validate phase, a verify phase, and a send message phase. Although not illustrated for ease of explanation, the prepare phase and commit phase also include fine-grained phases as illustrated by the ellipses. Thus, the tasks description 218 will include more individual tasks than the tasks descriptions 216 and 214, and the tasks description 216 will include more individual tasks than the task descriptions 214. Thus, the task descriptions 214, 216, and 218 may be viewed as a collection of individual tasks.

As previously described, in a BFT algorithm different nodes are replicated, which means each node can follow their own granularity scheme, introducing more heterogeneity into the overall system. The examples shown in FIG. 2B can all be present within the same system. This means that the code for one node could have been generated using granularity B while the code for another node could have been generated using granularity C, provided that the definitions in B and C are complete enough to generate the desired implementations.

Returning to FIG. 2A, the tasks descriptions 214, 216, and 218 are then sent to a code generation component 220. The code generation component, which in some embodiments is a Large Language Model (LLM) agent including one or more LLMs, will produce different code variations for all the given tasks descriptions 214, 216, and 218. The different code variations are referred to herein as code snippets or templates 222.

As input the code generation component 220 receives a collection of task descriptions that function as user prompts for the LLMs, a key or identifier of any type that identifies the collection of task descriptions, an ordering that specifies different splits of a given task and the order the tasks should be implemented in, and other metadata that provides additional information as needed. For example, the code generation component 220 may receive a collection of tasks having the following:
5. Key=’00001’, Ordering=’ 1/7’, Task=’Write a function that will receive as input a string and will return the string in reverse order’
6. Key=’00001’, Ordering=’ 2/7’, Task=’Write a function that will receive as input two strings, and will return a true value if one string is the reverse of the other and return false otherwise’
7. Key=’00001’, Ordering=’ 3/7’, Task=’. . . ’

It will be noted that the same key can have multiple task descriptions, or wordings, for the same ordering, provided the functionality is the same. This can add an additional layer of variability on the n-programming objective.

FIG. 2C illustrates a more detailed view of the code generation component 220. As illustrated, the code generation component 220 includes an LLM 220A and any number of additional LLMs 220B as illustrated by the ellipses that are capable of generating code based on input received by the code generation component 220.

The code generation component 220 receives as input one or more of the tasks descriptions 214, 216, and 218. As illustrated, the tasks descriptions 214 includes an identifier or key 214A and an ordering 214B. The tasks descriptions 214 may also include various metadata 214C that includes other information as needed. The tasks descriptions 214 also includes an individual task description 214D, an individual task description 214E and any number of additional individual task descriptions 214F as illustrated by the ellipses. The individual task descriptions 214D, 214E, and 214F are textual descriptions for the individual tasks that comprise the collection of tasks of the tasks descriptions 214 that act as prompts for the LLMs 220A and/or 220B when generating code snippets. Thus, in the embodiment the individual task descriptions 214D, 214E, and 214F represent the individual tasks for each phase of the pBFT protocol at the granularity A discussed previously.

The tasks descriptions 216 includes a key or identifier 216A and an ordering 216B. The tasks descriptions 216 may also include various metadata 216C that includes other information as needed. The tasks descriptions 216 also includes an individual task description 216D, an individual task description 216E, and any number of additional individual task descriptions 216F as illustrated by the ellipses. The individual task descriptions 216D, 216E, and 216F are textual descriptions for the individual tasks that comprise the collection of tasks of the tasks descriptions 216 that act as prompts for the LLMs 220A and/or 220B when generating code snippets. Thus, in the embodiment the individual task descriptions 216D, 216E, and 216F represent the individual tasks for each phase of the pBFT protocol at the granularity B discussed previously.

The tasks descriptions 218 includes a key or identifier 218A and an ordering 218B. The tasks descriptions 218 may also include various metadata 218C that includes other information as needed. The tasks descriptions 218 also includes an individual task description 218D, an individual task description 218E, and any number of additional individual task descriptions 218F as illustrated by the ellipses. The individual task descriptions 218D, 218E, and 218F are textual descriptions for the individual tasks that comprise the collection of tasks of the tasks descriptions 218 that act as prompts for the LLMs 220A and/or 220B when generating code snippets. Thus, in the embodiment the individual task descriptions 218D, 218E, and 218F represent the individual tasks for each phase of the pBFT protocol at the granularity C discussed previously.

Once the code generation component 220 receives the input, the code generation component 220 will, for the collection of platforms and languages that it can handle, generate the code snippets 222. As illustrated, the code snippets 222 include a code snippet 224, a code snippet 226, a code snippet 228, and any number of additional code snippets 229 as illustrated by the ellipses.

As further illustrated, the code snippet 224, which is a code snippet for the individual task description 214D of the tasks description 214, includes the key 214A, the ordering 214B, and the textual individual task description 214D that act as prompts for the LLMs 220A and/or 220B. The code snippet 224 also includes code 224A, which is the code generated by the LLMs 220A and/or 220B based on the textual individual task description 214D, and the language 224B of the code 224A. Although not illustrated, the code snippets 226, 228, and the additional code snippets 229, for the individual task associated with the code snippet, also include a key, an ordering, and a textual individual task description that act as prompts for the LLMs 220A and/or 220B and also includes the code generated by the LLMs 220A and/or 220B and the language of the code.

As described previously, the pBFT protocol at the granularity C includes a send message task. FIG. 2D illustrates how the LLMs 220A and/or 220B can be used to generate different versions of code for the send message task using different types of languages to improve resiliency. For example, in an example embodiment a local instance of an LLM 220A, which in the embodiment is a Language Model CodeGemma, is used to generate a POST request function with parameters message and node_address to the endpoint http://node_address:/0/prepare, representing the send message task in pBFT prepare phase. FIG. 2D shows at 221 generated code for C++ using SHA-2 cryptography, FIG. 2D shows at 223 generated code for Python with SHA-1 cryptography, and FIG. 2D shows at 225 generated code for Rust with SHA-2 cryptography.

Note that although being generated by an LLM, all the variations of the send_message( ) function have the same signature, i.e., name, parameters and return type. In the end, this kind of convention could ease the portability of the given code among existing implementations of pBFT.

BFT-based algorithms, in general, will have a lot of routine replications because every node will need to perform the same set of tasks, validations and protocol phases. The embodiments disclosed herein can produce several variations and combinations on different languages, communication protocols, and cryptography for each time the routine is replicated.

To introduce extensible resilience into the system 200, if a vulnerability is detected on a specific variation of the system, to make sure that the system will not collapse or will be exploited further, the system can deny and prevent such variations, by notifying the occurrence to the update component 270. This property is especially powerful in a BFT/DLT environment because the algorithm itself has a built-in resiliency to support faults or node takeovers without compromising system consensus.

Furthermore, the embodiments disclosed herein are not bound to any specific variation or code generation software/model, which allows for use case flexibility and different performance requirements. In fact, the use of different code generation models or techniques increases code diversity and resiliency, even further, thus resulting in node replications with greater variations. Returning to FIG. 2A, the generated code snippets 222 are then stored in a code snippets database 230, which may be any reasonable database. The code snippets database 230 maintains the code snippets 222 and also maintains a state of the code snippets bases on input from the code generation component 220 and an update component 270 that will be described in further detail to follow.

FIG. 2E illustrates a more detailed view of the code snippets database 230. As illustrated, the code snippets database 230 includes the generated code snippets 222, include the code snippet 224, code snippet 226, code snippet 228, and the additional code snippets 229 illustrated by the ellipses. Thus, the code snippet 224 includes the key 214A, the ordering 214B, the textual individual task description 214D, the code 224A, and the language 224B of the code 224A.

In order to maintain the state of the database and the code snippets 222, various metadata is added to the stored code snippets 222 by various elements of the system 200 including the code generation component 220 and the update component 270. In some embodiments, some of the metadata shown as included in FIG. 2E corresponds to the metadata 214C, 216C, and 218C previously described. In some embodiments, all of the metadata that is shown in FIG. 2D is included in a code snippet. However, this is not required as a code snippet can have only a subset of the metadata shown in FIG. 2E as circumstances warrant. Thus, the fact that the code snippet 224 is shown as including all of the metadata is for ease of explanation only and does not imply that the code snippet 224 must include all of the metadata.

As illustrated, the code snippet 224 includes select count metadata 231 that specifies the number of times that the code snippet 224 is selected by a package building component 240 when building node replication code as will be explained in more detail to follow. The code snippet 224 includes accept count metadata 232 that specifies the number of times the code snippet 224 (or the node replication code including the code snippet 224) is applied and accepted by a deploy component 280. The code snippet 224 includes deploy count metadata 233 that specifies the number of times the code snippet 224 (or the node replication code including the code snippet 224) is actually deployed by the deploy component 280. The code snippet 224 includes deploy platform list metadata 234 that specifies a list of the different platforms that the code snippet 224 (or the node replication code including the code snippet 224) was deployed on. It will be appreciated that since one of the purposes of the embodiments disclosed herein is to ensure that node replications have as much variation as possible, knowing the number of time that a code snippet is selected for use when building node replication code, the number of times a code snippet is accepted for and then deployed, and the number of different platforms that the code snippet was deployed on are important to know so as to ensure that the code snippet is not overused when building node replication code, thus decreasing the variation of the resulting node replications.

The code snippet 224 includes error count metadata 235 that specifies a number of errors in using the snippet. The code snippet 224 includes error message list metadata 236 that specifies a list of errors and error messages associated with the code snippet 224, which may be used for provenance and selection purposes. For example, if certain node replication code fails to compile, all snippets involved with the failure will have their error counts increased, and an error message added to their error message list. The code snippet 224 includes severity metadata 237 which specifies a maximum severity of the errors found in the snippet. The number of severity levels is application dependent, but in some embodiments should have at least two severity levels: no severity and high severity. No severity means that the snippet can be used, high severity means that the snippet cannot be used. Other severity levels can be created for specific purposes. For example, a solution may have a platform dependent severity level, that will be used to prevent the deployment of a particular snippet on a particular platform but allow it in other platforms. The metadata 235-237 is usable by the package building component 240 to decide if it is going to use the code snippet 224 since a code snippet that causes a large number of errors, or a high level of severe errors should not be used to build the node replication code.

In some embodiments, the code snippet 224 includes other metadata 238, which may include any other needed information that is useful to know about the code snippet 224. Although not illustrated for ease of explanation, the code snippet 226, code snippet 228, and the additional code snippets 229 illustrated by the ellipses may also include all of or any subset of the metadata 231-238 discussed in relation to code snippet 224.

In some embodiments, metadata 231-238 will be instantiated with sensible null values and will be updated during the lifetime of the system 200. For example, if a certain code snippet is affected by an exploit in the running environment, then its error count, error message and error severity (in this case, as high as possible) should be updated accordingly. If a certain code snippet is eventually used to build a feasible node replication code that could eventually be deployed, its usage count should be increased. If a certain code snippet is eventually deployed, its deploy count should be increased accordingly.

Returning to FIG. 2A, the code snippets 222 are then combined by the package building component 240. The package building component 240 is responsible for generating proper combinations of the code snippets 222 to build the complete code needed for node replications for a given platform. For example, as illustrated the package building component 240 builds node replication code 242, node replication code 244, and node replication code 246 using different combinations of the code snippets 222 for a given platform such as the pBFT protocol. That is, the node replication code 242 includes a combination of the code snippets 222 that is different from the combination of the code snippets used by the node replication codes 244 and 246, the node replication code 244 includes a combination of the code snippets 222 that is different from the combination of the code snippets used by the node replication codes 242 and 246, and the node replication code 246 includes a combination of the code snippets 222 that is different from the combination of the code snippets used by the node replication codes 242 and 244. This is represented by different shapes shown in FIG. 2A. These different combinations of the code snippets 222 result in node replications that are different from each other and thus less likely to become vulnerable to the same type of malicious attack.

In more detail, the package building component 240 will peruse the code snippets database 230 and generate the node replication code to be deployed on a particular platform. Each node replication code will be built with all orderings of a particular key of the same language, provided their severity levels are acceptable. The package building component 240 should function in a way that optimizes the variability and safety of the selected code snippets 222. The output of the package building component 240 (i.e., the node replication code 242, node replication code 244, and node replication code 246) is a deployable instance of the desired code that can be implemented in any deploy infrastructure as Docker Containers or Kubernetes, for example, or any other available fully functional deployment environment. In some embodiments, the node replication code 242, node replication code 244, and node replication code 246 include all the metadata 231-238 and may further include the following additional metadata:platform and creation date.

The output of the package building component 240 is then tested by a test component 250. The tests performed by the test component 250 should guarantee that the built node replication codes 242, 244, and 246 are behaving as expected in the target platforms. In the embodiments, the tests performed by the test component 250 are application and business requirement dependent, and the embodiments disclosed herein can be easily adapted to manage different applications and business requirements.

All of the node replication codes that fail the test are sent to a reject pool 260 and are marked for rejection, along with the test result. These are sequentially forwarded to the update component 270, which, in turn, updates the code snippets database 230 accordingly, for example, by removing from the code snippets database 230 a code snippet 222 that did not perform as expected, or adding metadata to the code snippet 222 tagging that the code snippet should not be implemented on a given platform. As illustrated in FIG. 2A, the node replication code 242 fails the tests performed by the test component 250 and is thus sent to the reject pool 260.

All of the node replication codes that pass the tests performed by the test component 250 are sent to an accept pool 265 and are marked for acceptance, so that they can later be deployed as needed. As illustrated in FIG. 2A, the node replication codes 244 and 246 pass the tests performed by the test component 250 and are thus sent to the accept pool 265.

The node replication codes in the accept pool 265 can then be deployed by a deploy component 280 when need be. When the deploy component 280 deploys the node replication codes 244 or 246 to be part of a deployment 282, which is some embodiments is a BFT quorum, the update component 270 is notified so that the corresponding code snippets 222 in the code snippets database 230 are updated with a “deployed” tag. This information can be later used by the package building component 240 to introduce as much variety as possible in future builds.

The deployment 282 is dynamically monitored by a monitoring component 290. If a failure, error, or an exploit is found by the monitoring component 290, then the deploy component 280 and the update component 270 are notified. The affected code snippets 222 may be tagged for certain platforms or removed from the code snippets database 230 by the update component 270. In addition, the affected node replication codes in the accept pool are removed, and the affected replicated nodes (such as one or more of the node N₀. . . Nₙ in the BFT quorum) in the deployment 282 are undeployed by the deployment component 280. In such case, a new fresh and safe node replication code from the accept pool 265 can be deployed to the deployment 282.

In more detail, the monitoring component 290 can support runtime monitoring of the jobs by tracking which combinations were assigned to which routines and evaluating nodes for bugs, vulnerabilities, or errors.

In a BFT or DLT environment, the monitoring component 290 would look for nodes that constantly timeout or take longer than the average distribution to process a request and for nodes that constantly diverge from consensus. All of these can be compared against historical distribution data from non-faulty nodes. A node with a delay or constant timeout might indicate a low-performance library/code or a vulnerability that was exploited to delay the system. A node that constantly diverges from consensus, represents an attacker who was able to hijack the node and is trying to subvert the quorum consensus.

FIG. 2F illustrates a more detailed view of the monitoring component 290 and its operation in conjunction with the code snippets database 230 and the update component 270. As illustrated, the code snippets database 230 stores various code snippets 222, including code snippets 291A, 291B, 291C, 292A, 292B, 292C, 293A, 293B, 293C, and 294. The code snippets 291A-291C are built into node replication code and deployed as node replication A, the code snippets 292A-292C are built into node replication code and deployed as node replication B, and the code snippets 293A-293C are built into node replication code and deployed as node replication C.

As previously discussed, the monitoring component 290 monitors the node replications A-C in real time. During the monitoring, the monitoring component 290 depicts abnormal behavior in the node replication B. In response, the monitoring component 290 can probe the node replication B to understand which of the underlying code snippets is causing the abnormal behavior. In the illustrated embodiment, the monitoring component 290 determines that the code snippet 292A is causing the abnormal behavior and thus has been exploited.

The monitoring component 290 then reports this exploit to the update component 270, which is able to update one or more of the metadata of the code snippet 292A in the code snippets database 230 to indicate that the code snippet 292A should no longer be used as represented by the “X” in the figure. In response, a new node replication B is generated and deployed that includes the code snippet 294 and the code snippets 292B and 292C.

Additionally, an external security or monitoring system 295 can notify the monitoring component 290 of an existing or recently known vulnerability determined by external sources such as the user of the system 200, so that the monitoring component 290 can trigger the update component 270 and the deployment component 280 to take the corresponding safety procedures such as when the monitoring component 290 detects an issue by itself. For example, a human user of the system 200 may discover a new attack against the replicated nodes in the deployment 282. This new attack may be referred to as “zero day” attack. Because it may take some time before the monitoring component 290 would be able to discover the attack, the human user can use the external security or monitoring system 295 to notify the monitoring component 290 of the attack so that the system 200 can take appropriate action.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

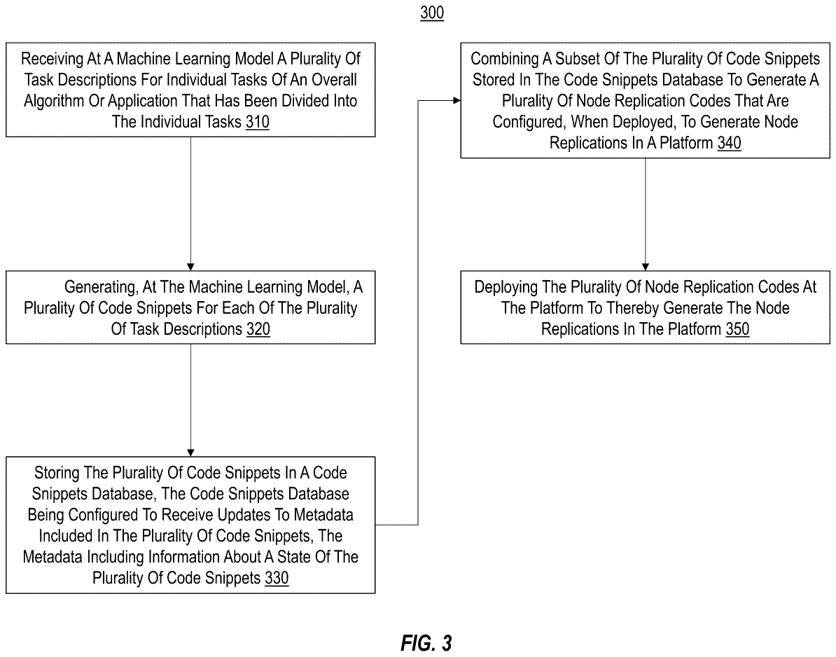

Directing attention now to FIG. 3, an example method 300 is disclosed. The method 300 will be described in relation to one or more of the figures previously described, although the method 300 is not limited to any particular embodiment.

The method 300 includes receiving at a machine learning model a plurality of task descriptions for individual tasks of an overall algorithm or application that has been divided into the individual tasks (310). For example, as previously described the code generation component 220 receives the tasks descriptions 214, 216, and 218 that include the individual tasks of the divided target application or algorithm 212.

The method 300 includes generating, at the machine learning model, a plurality of code snippets for each of the plurality of task descriptions (320). For example, as previously described the code generation component 220 generates the code snippets 222.

The method 300 includes storing the plurality of code snippets in a code snippets database, the code snippets database being configured to receive updates to metadata included in the plurality of code snippets, the metadata including information about a state of the plurality of code snippets (330). For example, as previously described the code snippets 222 are stored in the code snippets database 230. The code snippets include one or more of the metadata 231-238 that describes various states of the code snippets and that are updated by the update component 270.

The method 300 includes combining a subset of the plurality of code snippets stored in the code snippets database to generate a plurality of node replication codes that are configured, when deployed, to generate node replications in a platform (340). For example, as previously described the package building component 240 combines some of the code snippets 222 to build the node replication codes 242, 244, and 246.

The method 300 includes deploying the plurality of node replication codes at the platform to thereby generate the node replications in the platform (350). For example, as previously described the deploy component 280 deploys one or more of the node replication codes 242, 244, and 246 as the deployment 282 to thereby generate the replicated nodes in the platform.

### D. Further Example Embodiments

Following are some further example embodiments. These are presented only by way of example and are not intended to limit the scope of this disclosure or the claims in any way.

Embodiment 1. A method, comprising: receiving at a machine learning model a plurality of task descriptions for individual tasks of an overall algorithm or application that has been divided into the individual tasks; generating, at the machine learning model, a plurality of code snippets for each of the plurality of task descriptions; storing the plurality of code snippets in a code snippets database, the code snippets database being configured to receive updates to metadata included in the plurality of code snippets, the metadata including information about a state of the plurality of code snippets; combining a subset of the plurality of code snippets stored in the code snippets database to generate a plurality of node replication codes that are configured, when deployed, to generate node replications in a platform; and deploying the plurality of node replication codes at the platform to thereby generate the node replications in the platform.

Embodiment 2. The method of embodiment 1, further comprising: prior to deploying the plurality of node replication codes, performing one or more tests on the plurality of node replication codes to validate that the plurality of node replication codes are deployable on the platform.

Embodiment 3. The method of embodiments 1-2, wherein a first subset of the plurality of node replication codes that pass the one or more tests are included in an accept pool, the subset of the plurality of node replication codes included in the accept pool being deployed at the platform, and wherein a second subset of the plurality of node replication codes that do not pass the one or more tests are included in a reject pool.

Embodiment 4. The method of embodiments 1-3, further comprising: updating the metadata included in one or more of the plurality of code snippets based on whether a node replication code that includes the one or more of the plurality of code snippets passes the one or more tests.

Embodiment 5. The method of embodiments 1-4, further comprising: dynamically monitoring the node replications at the platform; detecting that there is an abnormality in one or more of the node replications; and updating the metadata included in one or more of the plurality of code snippets that are included in node replication codes used to generate the one or more node replications where the abnormality was detected.

Embodiment 6. The method of embodiments 1-5, wherein the overall algorithm or application is divided into the individual tasks based on different levels of granularity

Embodiment 7. The method of embodiments 1-6, wherein the machine learning model is one or more Large Language Models (LLM).

Embodiment 8. The method of embodiments 1-7, wherein the overall algorithm or application is a Byzantine Fault Tolerant (BFT) algorithm.

Embodiment 9. The method of embodiments 1-8, wherein the metadata includes one or more of select count metadata, accept count metadata, deploy count metadata, deploy platform list metadata, error count metadata, error message list metadata, and severity metadata.

Embodiment 10. The method of embodiments 1-9, wherein the code snippets include an identification key that identifies the individual tasks associated with each code snippet, an ordering that specifies an order the individual tasks should be implemented in, the task descriptions, code generated by the machine learning model, and a language of the code.

Embodiment 11. A system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

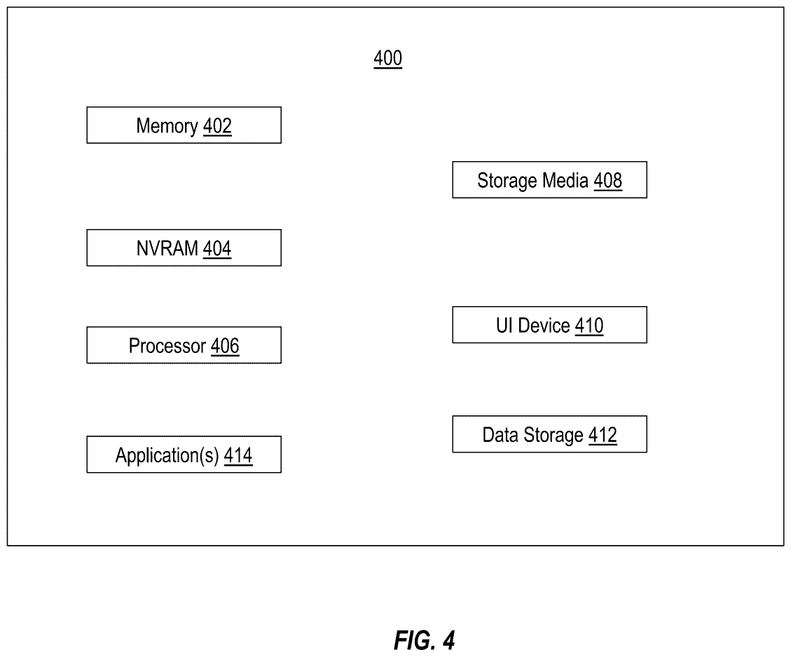

With reference briefly now to FIG. 4, any one or more of the entities disclosed, or implied, by FIGS. 1-3 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 404 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving at a machine learning model a plurality of task descriptions for individual tasks of an overall algorithm or application that has been divided into the individual tasks;
generating, at the machine learning model, a plurality of code snippets for each of the plurality of task descriptions;
storing the plurality of code snippets in a code snippets database, the code snippets database being configured to receive updates to metadata included in the plurality of code snippets, the metadata including information about a state of the plurality of code snippets;
combining a subset of the plurality of code snippets stored in the code snippets database to generate a plurality of node replication codes that are configured, when deployed, to generate node replications in a platform; and
deploying the plurality of node replication codes at the platform to thereby generate the node replications in the platform.

2. The method of claim 1, further comprising:
prior to deploying the plurality of node replication codes, performing one or more tests on the plurality of node replication codes to validate that the plurality of node replication codes are deployable on the platform.

3. The method of claim 2, wherein a first subset of the plurality of node replication codes that pass the one or more tests are included in an accept pool, the subset of the plurality of node replication codes included in the accept pool being deployed at the platform, and wherein a second subset of the plurality of node replication codes that do not pass the one or more tests are included in a reject pool.

4. The method of claim 2, further comprising:
updating the metadata included in one or more of the plurality of code snippets based on whether a node replication code that includes the one or more of the plurality of code snippets passes the one or more tests.

5. The method of claim 1, further comprising:
dynamically monitoring the node replications at the platform;
detecting that there is an abnormality in one or more of the node replications; and
updating the metadata included in one or more of the plurality of code snippets that are included in node replication codes used to generate the one or more node replications where the abnormality was detected.

6. The method of claim 1, wherein the overall algorithm or application is divided into the individual tasks based on different levels of granularity.

7. The method of claim 1, wherein the machine learning model is one or more Large Language Models (LLM).

8. The method of claim 1, wherein the overall algorithm or application is a Byzantine Fault Tolerant (BFT) algorithm.

9. The method of claim 1, wherein the metadata includes one or more of select count metadata, accept count metadata, deploy count metadata, deploy platform list metadata, error count metadata, error message list metadata, and severity metadata.

10. The method of claim 1, wherein the code snippets include an identification key that identifies the individual tasks associated with each code snippet, an ordering that specifies an order the individual tasks should be implemented in, the task descriptions, code generated by the machine learning model, and a language of the code.

11. A non-transitory storage medium having stored therein instructions that are executable by one or more hardware processors to perform operations comprising:
receiving at a machine learning model a plurality of task descriptions for individual tasks of an overall algorithm or application that has been divided into the individual tasks;
generating, at the machine learning model, a plurality of code snippets for each of the plurality of task descriptions;
storing the plurality of code snippets in a code snippets database, the code snippets database being configured to receive updates to metadata included in the plurality of code snippets, the metadata including information about a state of the plurality of code snippets;
combining a subset of the plurality of code snippets stored in the code snippets database to generate a plurality of node replication codes that are configured, when deployed, to generate node replications in a platform; and
deploying the plurality of node replication codes at the platform to thereby generate the node replications in the platform.

12. The non-transitory storage medium as recited in claim 11, further comprising:
prior to deploying the plurality of node replication codes, performing one or more tests on the plurality of node replication codes to validate that the plurality of node replication codes are deployable on the platform.

13. The non-transitory storage medium as recited in claim 12, wherein a first subset of the plurality of node replication codes that pass the one or more tests are included in an accept pool, the subset of the plurality of node replication codes included in the accept pool being deployed at the platform, and wherein a second subset of the plurality of node replication codes that do not pass the one or more tests are included in a reject pool.

14. The non-transitory storage medium as recited in claim 12, further comprising:
updating the metadata included in one or more of the plurality of code snippets based on whether a node replication code that includes the one or more of the plurality of code snippets passes the one or more tests.

15. The non-transitory storage medium as recited in claim 11, further comprising:
dynamically monitoring the node replications at the platform;
detecting that there is an abnormality in one or more of the node replications; and
updating the metadata included in one or more of the plurality of code snippets that are included in node replication codes used to generate the one or more node replications where the abnormality was detected.

16. The non-transitory storage medium as recited in claim 11, wherein the overall algorithm or application is divided into the individual tasks based on different levels of granularity.

17. The non-transitory storage medium as recited in claim 11, wherein the machine learning model is one or more Large Language Models (LLM).

18. The non-transitory storage medium as recited in claim 11, wherein the overall algorithm or application is a Byzantine Fault Tolerant (BFT) algorithm.

19. The non-transitory storage medium as recited in claim 11, wherein the metadata includes one or more of select count metadata, accept count metadata, deploy count metadata, deploy platform list metadata, error count metadata, error message list metadata, and severity metadata.

20. The non-transitory storage medium as recited in claim 11, wherein the code snippets include an identification key that identifies the individual tasks associated with each code snippet, an ordering that specifies an order the individual tasks should be implemented in, the task descriptions, code generated by the machine learning model, and a language of the code.
